(19) United States
(12) Patent Application Publication
(10) Pub. No.: US 2005/0029238 A1
(43) Pub. Date: Feb. 10, 2005

(54) Method for laser machining

(76) Inventor: Ga-Lane Chen, Fremont, CA (US)

Correspondence Address: WEI TE CHUNG;FOXCONN INTERNATIONAL, INC., 1650 MEMOREX DRIVE, SANTA CLARA, CA, 95050, US

(21) Appl. No.: 10/914,955

(22) Filed: Aug. 9, 2004

(30) Foreign Application Priority Data
Aug. 8, 2003 (TW) 92121872

(51) Int. Cl. B23K 26/38

(52) U.S. Cl. 219/121.71

(57) ABSTRACT

A method for laser machining includes the steps of: providing a workpiece (10); coating a protective layer (102) of polyimide on the workpiece; machining the workpiece with laser; and removing the protective layer with acetone solution or hydroxybenzene solution.

### BACKGROUND OF THE INVENTION

1. Field of the Invention

The present invention relates to a method for laser machining, and more particularly to a method for laser machining which reduces environment contamination to workpieces.

2. Description of the Related Art

A process such as a process of drilling a workpiece by laser light radiation has been performed heretofore. FIG. 4 is a schematic view, showing a hole 12′ is defined in a workpiece 10′ with a laser beam (not shown). The laser beam heats the workpiece 10′, substance composing the workpiece 10′ begins to melt and gasify, such that the hole 12′ is defined therein. However, the melted substance surrounding the hole 12′ may not completely evaporate, the remaining melted substance solidifies and forms protrusion 101′ atop a surface of the workpiece 10′. Furthermore, the evaporated substance solidifies in the air and deposits on the surface to form debris 103′. Therefore, the workpiece 10′ has to be polished to get smooth surface.

To address the aforesaid problem, Taiwan Patent No. 400555 discloses a new laser machining method which comprises coating a protective layer on a surface of a workpiece before laser machining. Debris produced in following laser machining deposits on the protective layer instead of the workpiece itself. The debris and the protective layer are removed together to get smooth workpiece surface through wet etch process. The protective layer is silicon oxide or silicon nitride layer. Silicon oxide or silicon nitride is deposited on the workpiece with Chemical Vapor Deposition (CVD) method. However, some poisonous or corrosive gas is used in the CVD method, and the CVD method needs expensive CVD equipment. The wet etch process removes the protective layer through chemical reaction. However, the wet etch process is in a strong acid solution, and the waste solution is corrosive and polluting.

Furthermore, the laser machining process is usually operated in a closed and clean workroom, for prevention of environment contamination such as dust. It will be desired to provide a process which can be operated in an ordinary workroom.

Thus, a laser machining process which overcomes the above-mentioned problems is desired.

### SUMMARY OF THE INVENTION

Accordingly, an object of the present invention is to provide a laser machining method which reduces environment contamination to workpieces and prevents machining defect.

A further object of the present invention is to provide a laser machining method which lowers manufacturing cost.

To achieve the above objects, a process for laser machining in accordance with the present invention comprises the steps of : providing a workpiece; coating a protective layer of polyimide on the workpiece; machining the workpiece with laser; and removing the protective layer with acetone solution or hydroxybenzene solution.

Other objects, advantages and novel features of the present invention will be drawn from the following detailed description of preferred embodiments of the present invention with the attached drawings, in which:

### BRIEF DESCRIPTION OF THE DRAWINGS

FIGS. 1 to 3 explanatorily show a process of laser machining in accordance with a preferred embodiment of the invention; and

FIG. 4 is an schematic view of a workpiece machined utilizing a conventional laser machining process.

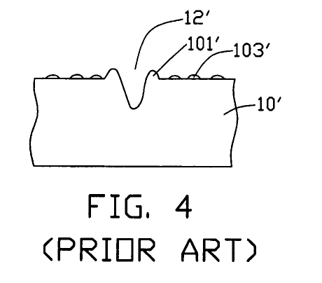

### DETAILED DESCRIPTION OF THE INVENTION

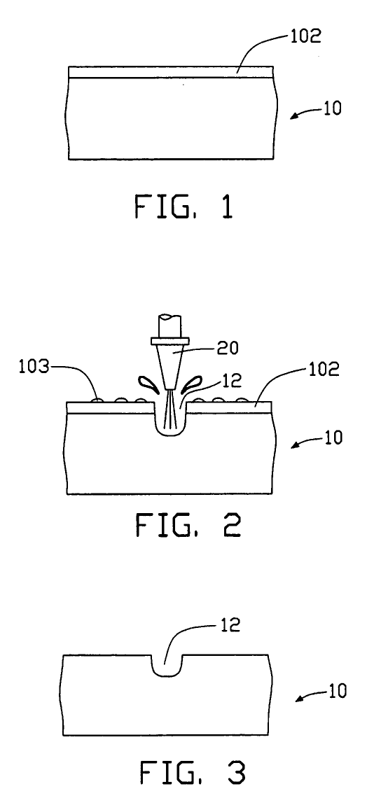

Referring to FIG. 1, firstly, a material is coated on a surface of a workpiece 10 to form a protective layer 102 utilizing dip coating method or spin coating method. In the preferred embodiment of the present invention, the material is polyimide, and a thickness of the polyimide layer is 500 angstroms to 500 microns.

Referring to FIG. 2, when a laser machining apparatus drills the workpiece 10 coated with the protective layer 102 to form a hole 12 therein, the laser beam heats the protective layer 102, and the protective layer 102 is firstly melted and gasified, then the workpiece 10 under the protective layer 102 is melted, such that the hole 12 is defined in the workpiece 10. The melted substance of the workpiece 102 is scattered on a surface of the protective layer 102, and then solidifies to form debris 103.

Referring to FIG. 3, after the hole 12 is formed in the workpiece 10, acetone solution or hydroxybenzene solution such as cresol solution is provided to dissolve the protective layer 102. When the protective layer 102 is dissolved in the solution, the debris 103 and environment dust, if any, deposited on the protective layer 102 are removed together with the dissolved protective layer 102, such that a clean surface of the workpiece 10 is achieved.

In the preferred embodiment, the protective layer 102 is removed by being dissolved in chemical solution, there is no chemical reaction in such dissolving process, and there is no corrosive or poisonous waste solution. Furthermore, the process is easy to operated, and there is no need for special equipments or machines. Because the environment dirt is deposited on the protective layer 102 in the preferred embodiment instead of the workpiece 10 in the typical process, the machining of the workpiece 10 can be carried out in an ordinary workshop instead of a closed and clean workshop. The polyimide is a common kind of chemical substance, and it is cheap.

In the preferred embodiment, the workpiece 10 can be metal or nonmetal. The type of machining on the workpiece 10 can also be engraving, cutting, texturing etc. other than drilling. The type of laser can be Nd:YAG, UV YAG, Nd:YVO₄, CO₂, etc.

While the present invention has been illustrated by the description of the preferred embodiment thereof, and while the preferred embodiment has been described in considerable detail, it is not intended to restrict or in any way limit the scope of the appended claims to such detail. Additional advantages and modifications within the spirit and scope of the present invention will readily appear to those skilled in the art. Therefore, the present invention is not limited to the specific details and illustrative examples shown and described.

1. A method for laser machining, comprising the steps of:
providing a workpiece;
coating a polyimide layer on the workpiece;
machining the workpiece with laser; and
removing the protective layer.

2. The method for laser machining as claimed in claim 1, wherein a thickness of the polyimide layer is 500 angstroms to 500 microns.

3. The method for laser machining as claimed in claim 2, wherein the polyimide layer is coated by dip coating or spin coating.

4. The method for laser machining as claimed in claim 1, wherein the polyimide layer is removed by being dissolved in acetone solution.

5. The method for laser machining as claimed in claim 1, wherein the polyimide layer is removed by being dissolved in hydroxybenzene solution.

6. The method for laser machining as claimed in claim 5, wherein the laser is Nd:YAG, UV YAG, Nd:YVO₄, or CO₂ laser.

7. A method for laser machining, comprising the steps of:
providing a workpiece;
coating a protective layer on the workpiece;
providing a laser machining apparatus to machine the workpiece; and
dissolving the protective layer in a solution.

8. The method for laser machining as claimed in claim 7, wherein the protective layer is polyimide layer, and the solution is acetone solution.

9. The method for laser machining as claimed in claim 7, wherein the protective layer is polyimide layer, and the solution is hydroxybenzene solution.

10. The method for laser machining as claimed in claim 9, wherein the hydroxybenzene solution comprises cresol solution.

11. A method for laser machining, comprising the steps of:
providing a workpiece with a flat face;
coating a protective layer on the flat face of the workpiece;
machining the workpiece with laser; and
removing the protective layer; wherein
said protective layer is removed by a dissolving procedure without involvement of chemical reaction.
